(19) United States
(12) Patent Application Publication
(10) Pub. No.: US 2015/0207757 A1
(43) Pub. Date: Jul. 23, 2015

(54) SHARED RESOURCE ALLOCATION CONTROL

(71) Applicant: HEWLETT-PACKARD DEVELOPMENT COMPANY, L.P., Houston, TX (US)

(72) Inventors: Lin A. Nease, Granite Bay, CA (US); Chuck A. Black, Rocklin, CA (US)

(21) Appl. No.: 14/676,261

(22) Filed: Apr. 1, 2015

Related U.S. Application Data
(62) Division of application No. 12/411,071, filed on Mar. 25, 2009, now abandoned.

(51) Int. Cl. H04L 12/923; H04L 12/911; H04L 12/26

(52) U.S. Cl. CPC H04L 47/762; H04L 43/0876; H04L 47/783

(57) ABSTRACT

A compilation of potentially shared resources is received. The potentially shared resources are analyzed to determine compatibility among the shared resources. A user accessible list of acceptable combinations of potentially shared resources is generated.

### CROSS-REFERENCE TO RELATED APPLICATION

This is a divisional of U.S. application Ser. No. 12/411,071, filed Mar. 25, 2009, which is hereby incorporated by reference.

### FIELD

Embodiments of the present technology relates generally to the field of networking.

### BACKGROUND

In certain environments resources are allocated. In computing environments there are various resources that can be allocated. In some instances, various resources are allocated within a computing network. Resources that are allocated in a computing environment can be but are not limited to servers, operating systems, applications, switches, load balancers, firewalls and the like.

### BRIEF DESCRIPTION OF THE DRAWINGS

FIG. 1 illustrates an example of a flow chart of a method for creating a shared resource allocation control configuration, in accordance with an embodiment of the present invention.

FIG. 2 illustrates an example of a flow chart of a method for provisioning potentially shared resources, in accordance with an embodiment of the present invention.

FIG. 3 illustrates an example of a flow chart of a method for provisioning potentially shared resources, in accordance with an embodiment of the present invention.

FIG. 4 illustrates an example of a computer system, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Modern networking provides an improvement in communication and information access. For example, in-house data centers, associated with a particular entity of interrelated group of users, could contain a large number of information technology (IT) resources that are interconnected through a network. These networks are configured in different ways depending on implementation-specific details such as the hardware used and the physical location of the equipment, and depending on the particular objectives of the network. One common type of network configuration is a local area network (LAN). In practice, a typical LAN will include large numbers of computer systems and switches (as well as other devices). Another common type of network configuration is a storage area network (SAN). In practice, a typical SAN will include large numbers of disk logical units (LUNs) of a disk array and switches (as well as other devices). Devices such as computer systems, routers, switches, load balancers, firewalls, and the like, are commonly linked to each other in networks.

Generally, data centers include technicians working from a network operation center (NOC). The technicians issue commands to control the deployment of servers and to control the supporting infrastructures, such as disk logical units (LUNs) in a disk array, network switches in the LAN, and switches in the SAN.

One example of an environment in which resources are shared and allocated dynamically in the aggregate is a utility data computing (UDC) environment. In a UDC environment, multiple resources such as but not limited to servers, operating systems, applications, switches, load balancers, firewalls and the like are shared resources which are allocated to various users in the UDC environment. Additionally, UDC environments can comprise an operations center local area network, a data center utility controller LAN and resource pools. By their very nature, UDC environments are flexible in their composition, comprising any number and types of devices and systems. It is this flexibility from which they derive their usefulness.

Typically, control and support of allocating resources in a computing infrastructure, such as but not limited to a UDC environment, can become very complicated and burdensome. A resource added to the infrastructure has to go through thorough testing to determine if a potential resource will affect other resources within the infrastructure. Consequently, a request for additional resources within the infrastructure can take an unreasonable amount of time to be approved and subsequently allocated within the computing infrastructure.

For further clarification, specific examples will follow in which the resource to be allocated is a server. It will be understood, as stated above, that various other resources can be allocated, however, for the purposes of brevity and clarity, we will use examples of a server.

Adaptive network management and control can be very burdensome and complex, as described above. In particular, a request to provision a new server within a network may take months of testing and validation to approve the allocation of the server within the network. Typically, a server administrator submits a request for the connectivity of a server within the network to a network team, such as an IT group or IT department. The server requested to be provisioned within the network often has different configurations that are required to be provisioned on the network for the server to properly function and deliver the requested services to the requesting user. For example, the requested server can have, but not limited to, two connections for making databases accessible on the network, one connection for a system administration function, one connection for backup of a data base system, one connection for a storage area network and a connection for a storage type connection on Ethernet to support a database server.

In another example, a web server is requested to be provisioned on the network. The web server can have many configurations which must be approved before the web server can be allocated within the network. The web server can be placed in a demilitarized zone (DMZ) which would then require changes to the configuration of the server load balancer and a firewall device.

Generally, the IT group will have a network services team and/or an ongoing change review board that must go through various analytical steps to determine how to fulfill the request of provisioning devices, such as a server, within the network. Moreover, different groups in an organization, such as finance and human resources, that use the network can also be required to approve the provisioning of the server. Each configuration must be evaluated in a network change review process. The review process can be very complicated because multiple devices and applications are touched. The IT group must determine that provisioning a server in the network will not oversubscribe the network and cause another device and/or application to fail. Adding and/or configuring multiple devices within a network will exponentially increase the complexity of controlling and managing the network.

Typically, the approval process to provision a device, such as a server, on a network consists of a manual process. Usually the approval to provision the server is a rigid response to the customer, who requests the server. For example, a rigid response could be a specific network location where the server could be plugged in, such as, a particular panel or port where the IT group has provisioned the network for that particular server. If the approval process is not purely manual, then the automatic portion of an approval process is a rigid switch architecture.

Another example that illustrates the typical solution to network management is a network port that might be used for numerous possible distinct server connections (i.e. a web server network interface card (NIC) connecting to a DMZ LAN, or an application server NIC connecting to a backup/archival LAN) must be configured with a permutation of all possible policies. In some cases, a port might be designated as a potential member of numerous concurrent potential VLAN assignments. Typically, network managers in IT need to either 1) manually configure switches per change ticket for each new server, 2) tightly control which types of server NICs are connected to which switches or network ports; or 3) both. Most of the policies configured for that port are irrelevant to actual use, because an edge port in the network will not be used concurrently for all these diverse functions. However, if there must be a single configuration of policies to fit all possible uses, these policies will be generic in nature, and tend to allow traffic to be forwarded that is not necessary to allow.

Thus, most IT departments standardize on very complex “cookie-cutter” configuration for network policies related to server connectivity or the like. In some cases, there may be hundreds of separate policies that are evaluated for every network frame arriving at the port, which can potentially impact the throughput of the device and exacerbate the difficulty in troubleshooting network problems. Simplification of such aggregated, generic policy permutations requires reducing the number of policies, which either compromises the level of security in the network, or forces network managers to maintain separate policy sets on multiple separate subnetworks.

In sum, networks are not standardized and if they are then they are standardized on very complex rigid configurations. This is a design-to-order model where the network is custom-integrated and dedicated piece-by-piece to individual applications, based on a top-down design for each application. Each application requires different platforms, with different OS revisions, patch levels, network topologies, security models and the like. Disruption of applications by other applications is too costly to justify sharing resources between them. Generally the applications are isolated in their infrastructure domain for the purpose of management and troubleshooting.

Additionally, there is no repetition of any given change and it is difficult to build quality or a pre-test. The impact of a custom change is unknown without comprehensive analysis. There is a lack of determination of whether or not the change is possible. If it is not possible, it probably won't be known with desired lead time to remediate. Unwinding the change may be impossible in a dynamic environment, since all “known states” are novel.

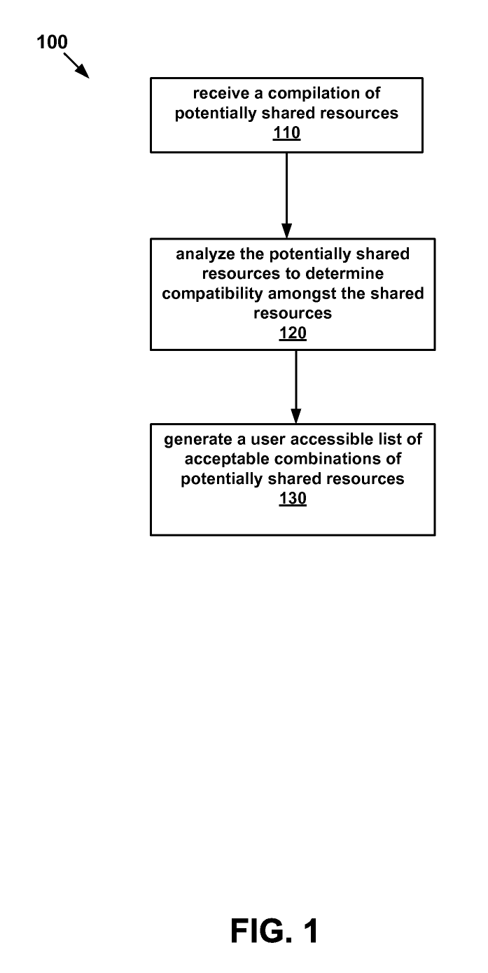

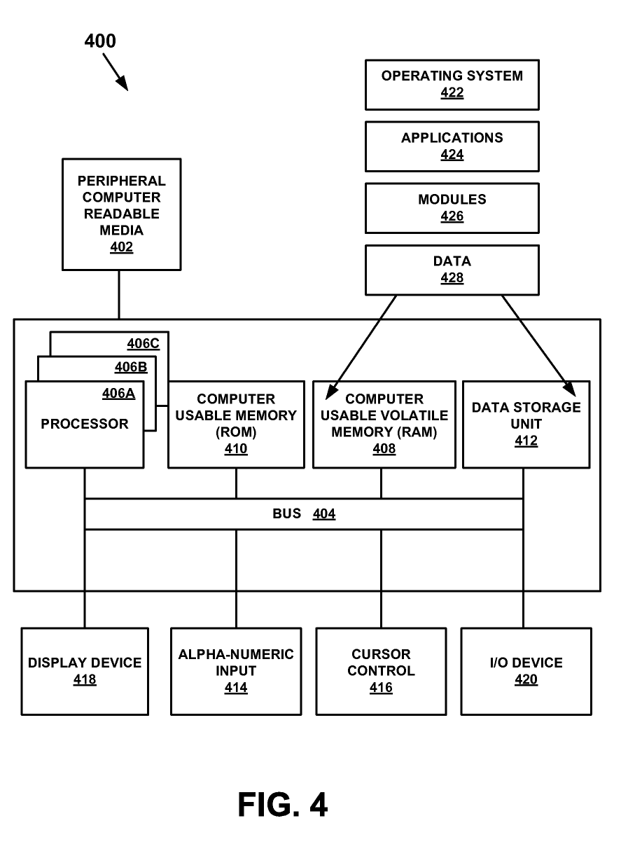

FIG. 1 depicts a method 100 for creating a shared resource allocation control configuration. Although specific operations are disclosed in method 100, such steps are examples. That is, embodiments of the present invention are well-suited to performing various other operations or variations of the operations recited in method 100. The operations in method 100 may be performed in an order different than presented, and it is possible that not all of the operations in method 100 are performed. All of, or a portion of, the operations described by method 100 may be implemented using computer-readable and computer-executable instructions which reside, for example, in computer-usable media of a computer system, such as but not limited to the computer system in FIG. 4. In one embodiment, method 100 is performed in a computer system, e.g., system 400 of FIG. 4. It should be appreciated that various operations have been left out of the following discussion for purposes of brevity and clarity.

In step 110, a compilation of potentially shared resources are received. In one embodiment, the potentially shared resources are servers and the compilation of shared resources can be, but are not limited to a list of standard server types.

Each server type has standards that are established by application and server architects. It can be appreciated that server standards are represented by a catalog of common deployment patterns. In one embodiment, the patterns are predicated on criteria such as, but not limited to: 1) server usage by tier (e.g. in a 3-tier model—web server, application server or database server); 2) operating system type (e.g. Windows, Linux or Unix); 3) application type (e.g. Exchange, Oracle, .Net, Apache); 4) departmental or group owner (e.g. servers belonging to “finance” distinguished from servers belonging to “operations” or “R&D”); and 5) server characteristics (e.g. small, medium, large). It can be appreciated, that the criteria, listed above, are shared resources.

Step 120 is analyzing the potentially shared resources to determine compatibility amongst the shared resources. In one embodiment, a network architect develops a list of connection profile templates for each standard server type. For example, a standard small Apache web server for external web site hosting might have six different connections (e.g. 2 DMZ, 2 intranet, 1 backup, 1 management LAN) which would each have a separate connection profile template.

In another embodiment, the network architect formulates a standard policy set for each profile template. For example, web servers on the DMZ might be prevented from sending traffic to any other device on the Layer 2 network except the gateway, in order to prevent a compromised server from attacking other servers. In another example, servers belonging to “finance” might be disabled from sending traffic to any devices belonging to “operations.” Policies, however, are cast as new allowances, rather than restrictions. This is done based on the assumption that all traffic will be blocked by default, and a new policy would be required to allow a specific traffic pattern to pass the network.

The new allowances, rather than restrictions, is appropriate for servers, because servers typically are more specialized than client devices. For example, a client PC device might need to access hundreds of diverse applications or services, while an email server provides only email services. This would reduce the number of distinct network traffic patterns a network manager would expect to ingress or egress a server as compared to a client device.

In another embodiment, each connection profile is accompanied by a set of policy forms. A policy form represents a specific set of actions to be taken by a particular policy decision and enforcement system. For example, a firewall system may have a specific command line instruction (CLI) with its own unique commands for setting an access control list (ACL). The policy form for the firewall would be a sequence of CLI commands that, when executed on the firewall, would inject the appropriate policy to be enforced for the new server connection being added. If there are five policy enforcement points for a new server connection, five different forms would be stored with specific information for enforcing that connection. In another example, a web server cluster might need a server load balancing policy, while a database server might not.

In one embodiment, compatibility is determined if there is no violation of a service level agreement (SLA). In another embodiment, compatibility is determined if there is no lowering of the quality of service (QOS).

Step 130 is generating a user accessible list of acceptable combinations of potentially shared resources. In one embodiment, once the profile templates have been developed, they are stored and made available for subsequent usage in actual server deployments.

In another embodiment, each template has an association identifier that is shared between the server deployment tool and the network configuration system. When the server deployment tool provisions a new server, a set of connection requests are sent by the server or a suitable proxy to the edge switch(es) of the network. The edge switch(es) then register the new connection by performing an authentication sequence, using the connection name to retrieve the policies. The policies associated with that server connection are then added to the edge switch's existing policy set that allows this new traffic pattern to pass. Subsequently, the policies stored in the connection policy forms are also executed on the various policy systems in the network.

In another embodiment, the user accessible list, in step 130, provides a user with an opportunity only to allocate acceptable combinations of potentially shared resources on a shared resource infrastructure. If the analysis of step 120 determines if a resource(s) is incompatible with other potentially shared resources and/or other resources that are currently in the network, the incompatible resources(s) are not placed in the user accessible list. The purpose of the user having an opportunity only to allocate acceptable combinations of potentially shared resources on a shared resource infrastructure is to standardize the network.

In another embodiment, there is an automatic culling from the user accessible list any potentially shared resources that are not compatible with a user selected potentially shared resource from the user accessible list. For example, if a “small web server” and a “high-pert DB LUN” are listed on the user accessible list, and a user selects a “small web server” to be provisioned in the network, the “high-pert DB LUN” will be automatically culled from the user accessible list in association with the user selecting a “small web server.”

To further illustrate, in another embodiment, the user accessible list includes servers A and B and operating systems (OS) A, B and C. Server A is only deemed to be compatible with OS A and B but is not compatible with OS C. If a user requests to provision server A, server B and OS C are automatically culled from the user accessible list. The user accessible list subsequently displays an option for OS A and B. The user then requests either OS A or B to be provisioned with server A.

In one embodiment, the shared resource infrastructure is a UDC environment. In another embodiment, the shared resource infrastructure is a SANS.

In general, method 100 provides for an allocate-to-order networking model. In one embodiment, the allocate-to-order networking model provides a new application to be assigned pre-existing resources, via a service binding. A service binding is a user is bound to a service. In one embodiment, the user accessible list is a menu of standard, pre-inventoried, well-known resources types. For example, “small Windows server” and “medium Windows server” may be two types of standard resources offered on the menu. When an application owner (the customer of the menu) selects “medium Windows server,” the owner will get exactly the same resource type that has been provided to any other “medium Windows server” customer. With the Allocate-to-Order networking model, infrastructure is provided as standard services from menus.

Additional benefits of an allocate-to-order networking model are that the infrastructure is fully standardized using a service menu. Changes in infrastructure are well-known and can be pre-approved. The time to analyze and approve changes within the infrastructure is dramatically reduced. Capacity management at the whole data center level is greatly enhanced and standardized pieces make troubleshooting much less complex.

Infrastructure standards can be layered, much like a supply chain. For example, a standard data base server type can be composed of standard LUNs and standard VLAN configurations. With the supply chain concept, standard resource offerings are each managed as if they were a product line, rather than simply a recipe. In one embodiment, each line is viewed as a small business having customers, suppliers, costs and forecasts. The entire product line is under change control (not just individual products). With adequate quality control, all products are essentially identical and consequently, processes for producing and managing each product are essentially identical. Each product line has a lifecycle and each product line is managed in the aggregate.

This approach provides significant benefits for IT service management. The benefits are, but not limited to better capacity management because aggregate capacity is managed against a proactive forecast; better problem management because all elements and their interactions are well-known and homogeneous; better change management because changes are no longer novel, allowing for better understanding and lower risk; and better quality because higher-volume, homogenous tasks increase repetition and experience.

Additional advantages are allowing IT to document pre-approved change tickets for network configuration and provide services using supply-chain methodology; explicitly enforces network architecture and design; allows IT to handle new server provisioning in a proactive rather than a reactive mode; automates actions that were once impractical to do manually; and enhances network security by only allowing known traffic patterns to traverse the network.

Also, it allows for seamless integration of future policy enforcement systems in the network. For example, data-loss protection or intrusion detection protection systems via the policy forms mechanism that would allow the new systems to integrate into the supply-chain process. The allocate-to-order network can provide a repository with specific instantiation, that richen the information available to capacity management, fault management, operations management, compliance checking, and service management.

In one embodiment, step 120 of method 100 occurs before a user requests the potentially shared resources to be provisioned on a shared resource infrastructure. The analyzing of potentially shared resources to determine compatibility amongst the shared resources also provides for standardization of the shared resource infrastructure. Only after the potentially shared resources are determined to be compatible are they deemed to be standardized resources that are potentially shared within the shared resource infrastructure.

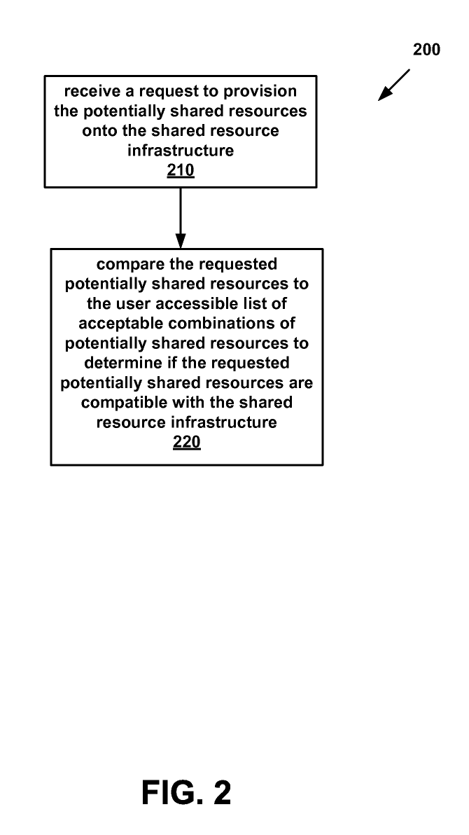

FIG. 2 depicts a method 200 for provisioning potentially shared resources from a user accessible list of acceptable combinations of potentially shared resources onto a shared resource infrastructure. Although specific operations are disclosed in method 200, such steps are examples. That is, embodiments of the present invention are well-suited to performing various other operations or variations of the operations recited in method 200. The operations in method 200 may be performed in an order different than presented, and it is possible that not all of the operations in method 200 are performed. All of, or a portion of, the operations described by method 200 may be implemented using computer-readable and computer-executable instructions which reside, for example, in computer-usable media of a computer system, such as but not limited to the computer system in FIG. 4. In one embodiment, method 200 is performed in a computer system, e.g., system 400 of FIG. 4. It should be appreciated that various operations have been left out of the following discussion for purposes of brevity and clarity.

At block 210, a request is received to provision the potentially shared resources onto the shared resource infrastructure. In one embodiment, the potentially shared resource requested to be received is a server. In another embodiment, the shared resource infrastructure is a UDC environment. In a further embodiment, the potentially shared resource is a SANS.

At block 220, the requested potentially shared resources are compared to the user accessible list of acceptable combinations of potentially shared resources to determine if the requested potentially shared resources are compatible with said shared resource infrastructure.

In one embodiment, method 200 comprises allocating the requested potentially shared resources onto the shared resource infrastructure, if the potentially shared resources are on the user accessible list of acceptable combinations of potentially shared resources. If the potentially shared resources are on the user accessible list of acceptable combinations of potentially shared resources, the potentially shared resources are standardized and pre-approved to be allocated within the shared resource infrastructure.

In one embodiment, method 200 provides a user with an opportunity only to allocate acceptable combinations of resources on a shared resource infrastructure. The purpose of the user having an opportunity only to allocate acceptable combinations of potentially shared resources on a shared resource infrastructure is to standardize the network, as described above. In another embodiment, method 200 provides for automatically culling from the user accessible list any potentially shared resources that are not compatible with a user selected potentially shared resource from said user accessible list.

In one embodiment, method 200 provides for allocating the requested potentially shared resources onto the shared resource infrastructure occurs in real-time, if the potentially shared resources are on the user accessible list of acceptable combinations of potentially shared resources. The user accessible list contains potentially shared resources that are standard, pre-inventoried and pre-approved to be allocated within the shared resource infrastructure. Therefore, once a potentially shared resource that is on the user accessible list is requested to be provisioned on the shared resource infrastructure, it can automatically be allocated in real-time within the shared resource infrastructure.

In one embodiment, method 200 comprises allocating resources on the user accessible list that are different than the requested potentially shared resources onto the shared resource infrastructure, if the requested potentially shared resources are not on the user accessible list. For example, if requirements for an application dictate a 4-CPU Linux server with 4 Gigabytes of memory, a request would be made for a 4-CPU Linux server with 4 Gigabytes in the resource menu. If a server with those requirements is on the menu, then that server will be allocated in real-time within the network. If only a “small Linux server” is on the menu, having enough CPU cores but not enough memory, then a selection must be made for another menu option. The menu may only have an 8-core server with 4 Gigabytes of memory, which is then selected and allocated in real-time. Because the infrastructure is managed in the aggregate, the 8-core server selection is not sub-optimal.

In another embodiment, the user accessible list is updated in light of allocating the requested potentially shared resources onto the shared resource infrastructure. Referring to the aforementioned example, if the 8-core server was the only server of its kind on the menu, then the updated menu would not list the 8-core server because it has been subsequently allocated within the network. Likewise, if there are five 8-core servers initially listed on the menu, only four 8-core servers would be listed on the updated menu after allocation of the 8-core server.

In another embodiment, method 200 comprises provisioning potentially shared resources from a user accessible list of acceptable combinations of potentially shared resources onto a shared resource infrastructure without requiring approval from a third party. As stated above, typically at least an IT group (a third party) must analyze a requested resource and subsequently approve the requested resource to be allocated within a network. This typical approval process is not required, because the potentially shared resources are pre-approved when listed in the user accessible list of potentially shared resources.

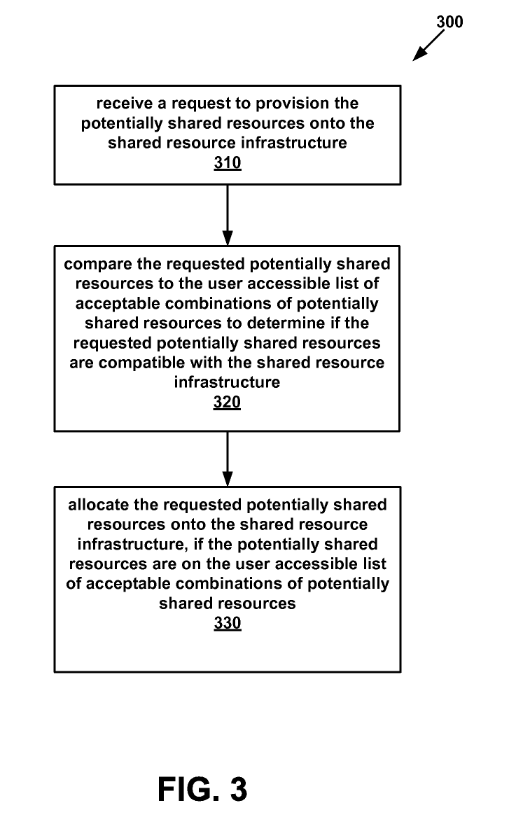

FIG. 3 depicts a method 300 for provisioning potentially shared resources from a user accessible list of acceptable combinations of potentially shared resources onto a shared resource infrastructure. Although specific operations are disclosed in method 300, such steps are examples. That is, embodiments of the present invention are well-suited to performing various other operations or variations of the operations recited in method 300. The operations in method 300 may be performed in an order different than presented, and it is possible that not all of the operations in method 300 are performed. All of, or a portion of, the operations described by method 300 may be implemented using computer-readable and computer-executable instructions which reside, for example, in computer-usable media of a computer system, such as but not limited to the computer system in FIG. 4. In one embodiment, method 300 is performed in a computer system, e.g., system 400 of FIG. 4. It should be appreciated that various operations have been left out of the following discussion for purposes of brevity and clarity.

In one embodiment, the shared resource infrastructure is a UDC environment. At block 310, a request is received to provision the potentially shared resources onto the shared resource infrastructure. At block 320, the requested potentially shared resources are compared to the user accessible list of acceptable combinations of potentially shared resources to determine if the requested potentially shared resources are compatible with said shared resource infrastructure. At block 330, the requested potentially shared resources are allocated onto the shared resource infrastructure, if the potentially shared resources are on the user accessible list of acceptable combinations of potentially shared resources.

In one embodiment, the requested potentially shared resources are pre-approved to be allocated, if the potentially shared resources are on the user accessible list of acceptable combinations of potentially shared resources. In another embodiment, the user accessible list is updated in light of the allocating of the requested potentially shared resources onto the shared resource infrastructure. In a further embodiment, method 300 provides for the allocating of resources on the user accessible list that are different than the requested potentially shared resources onto the shared resource infrastructure, if the potentially requested resources are not on the user accessible list.

It can be appreciated that various embodiments provides for a significant reduction in labor cost due to the automation and design of combined server/network provisioning; enables greater precision in data center network configuration because each server's connectivity can be specifically tailored for ACLs, filters, policies, VLAN assignment and the like; allows the network to restrict threatening or unnecessary traffic because the network can assume it has been precisely informed of all traffic that it must allow; enable precise information monitoring tools because servers are explicitly authenticated with requisite information which is cross-referenced in a persistent store for authentication purposes; enables a consolidated network agency on behalf of server endpoints, via aggregation and virtualization edge devices that separate server connections form the rest of the data center network; and allows configuration of multiple policy enforcement points to be automated on behalf of each server connection.

With reference now to FIG. 4, portions of the technology for providing a communication composed of computer-readable and computer-executable instructions that reside, for example, in computer-usable media of a computer system. That is, FIG. 4 illustrates one example of a type of computer that can be used to implement embodiments of the present technology.

FIG. 4 illustrates an example computer system 400 used in accordance with embodiments of the present technology. It is appreciated that system 400 of FIG. 4 is an example only and that the present technology can operate on or within a number of different computer systems including general purpose networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet. A more detailed discussion of the present technology is found below.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described system 400. For example, a method of modifying user interface 225A of device 115A may be applied to operating system 422, applications 424, modules 426, and/or data 428.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

1. A method for creating a shared resource allocation control configuration, the method comprising:
receiving a compilation of potentially shared resources;
analyzing, by a computer system, the potentially shared resources to determine compatibility among the potentially shared resources; and
generating, by the computer system in response to the analyzing, a user accessible list of acceptable combinations of potentially shared resources, wherein the generating of the user accessible list comprises automatically culling from the user accessible list a potentially shared resource that is not compatible with a user selected potentially shared resource from the user accessible list.

2. The method of claim 1, wherein the analyzing identifies a given potentially shared resource of the compilation of potentially shared resources as incompatible with at least one other potentially shared resource of the compilation of potentially shared resources, and wherein generating the user access list comprises not including the given potentially shared resource in the user accessible list.

3. The method of claim 1, further comprising:
receiving user selection of the user selected potentially shared resource for provisioning in a shared resource infrastructure,
wherein the culling is responsive to the receiving of the user selection of the user selected potentially shared resource.

4. The method of claim 1, wherein the analyzing comprises determining compatibility between a first potentially shared resource and a second potentially shared resource responsive to determining that a combination of the first and second potentially shared resources does not violate a service level agreement.

5. The method of claim 1, wherein the analyzing comprises determining compatibility between a first potentially shared resource and a second potentially shared resource responsive to determining that a combination of the first and second potentially shared resources does not lower a quality of service.

6. The method of claim 1, wherein generating the user accessible list of acceptable combinations of potentially shared resources comprises generating a menu of acceptable combinations of resource types.

7. The method of claim 6, wherein a resource type of the menu of acceptable combinations of resource types is composed of a plurality of different types of resources.

8. The method of claim 1, wherein the analyzing occurs before a user requests potentially shared resources of the compilation of potentially shared resources to be provisioned on a shared resource infrastructure.

9. The method of claim 1, wherein the generating of the user accessible list of acceptable combinations of potentially shared resources comprises:
providing a user with an opportunity only to allocate the acceptable combinations of potentially shared resources on a shared resource infrastructure.

10. The method of claim 1, further comprising:
utilizing the potentially shared resources of the acceptable combinations in the user accessible list in a shared resource infrastructure, wherein the shared resource infrastructure is a utility data computing environment or a storage area network.

11. The method of claim 1, wherein the potentially shared resources of the compilation are selected from among a type of server, a type of operating system, and a type of application.

12. The method of claim 1, further comprising:
receiving a request to provision potentially shared resources onto a shared resource infrastructure;
comparing the potentially shared resources of the request to the user accessible list of acceptable combinations of potentially shared resources; and
allocating the potentially shared resources of the request onto the shared resource infrastructure, in response to determining, based on the comparing, that the potentially shared resources of the request are on the user accessible list of acceptable combinations of potentially shared resources.

13. The method of claim 12, further comprising:
in response to determining, based on the comparing, that the potentially shared resources of the request are not on the user accessible list, allocating resources on the user accessible list that are different than the potentially shared resources of the request onto the shared resource infrastructure.

14. The method of claim 12, further comprising:
updating the user accessible list in response to allocating the potentially shared resources of the request onto the shared resource infrastructure.

15. A system comprising:
at least one non-transitory machine-readable storage medium storing instructions; and
at least one processor, the instructions executable on the at least one processor to:
receive a compilation of potentially shared resources;
analyze the potentially shared resources to determine compatibility among the potentially shared resources; and
generate, in response to the analyzing, a user accessible list of acceptable combinations of potentially shared resources, wherein the generating of the user accessible list comprises automatically culling from the user accessible list a potentially shared resource that is not compatible with a user selected potentially shared resource from the user accessible list.

16. The system of claim 15, wherein the analyzing identifies a given potentially shared resource of the compilation of potentially shared resources as incompatible with at least one other potentially shared resource of the compilation of potentially shared resources, and wherein generating the user access list comprises not including the given potentially shared resource in the user accessible list.

17. The system of claim 15, wherein the analyzing comprises determining compatibility between a first potentially shared resource and a second potentially shared resource responsive to determining that a combination of the first and second potentially shared resources does not violate a service level agreement.

18. The system of claim 15, wherein the analyzing comprises determining compatibility between a first potentially shared resource and a second potentially shared resource responsive to determining that a combination of the first and second potentially shared resources does not lower a quality of service.

19. The system of claim 15, wherein the instructions are executable to further:
receive a request to provision potentially shared resources onto a shared resource infrastructure;
compare the potentially shared resources of the request to the user accessible list of acceptable combinations of potentially shared resources; and
allocate the potentially shared resources of the request onto the shared resource infrastructure, in response to determining, based on the comparing, that the potentially shared resources of the request are on the user accessible list of acceptable combinations of potentially shared resources.

20. A non-transitory machine-readable storage medium storing instructions that upon execution cause a system to:
receive a compilation of potentially shared resources;
analyze the potentially shared resources to determine compatibility among the potentially shared resources; and
generate, in response to the analyzing, a user accessible list of acceptable combinations of potentially shared resources; and
receive user selection of a user selected potentially shared resource for provisioning in a shared resource infrastructure; and
responsive to receiving the user selection, cull from the user accessible list a potentially shared resource that is not compatible with the potentially shared resource of the user selection.
